(19) United States
(12) Patent Application Publication
(10) Pub. No.: US 2008/0001959 A1
(43) Pub. Date: Jan. 3, 2008

(54) System, Method and Computer Program Product for Performing Information Transfer Using a Virtual Operator

(76) Inventors: Amir Geva, Yokne'am Ilit (IL); Eugeniusz Walach, Haifa (IL)

Correspondence Address: IBM CORPORATION, T.J. WATSON RESEARCH CENTER, P.O. BOX 218, YORKTOWN HEIGHTS, NY, 10598, US

(21) Appl. No.: 11/426,949

(22) Filed: Jun. 28, 2006

(51) Int. Cl. G06F 13/00

(52) U.S. Cl. 345/537

(57) ABSTRACT

A system, computer program product and a method for performing information transfer, the method includes: executing, by a virtual operator, a first set of input operations such as to cause a computerized system to generate first image information representative of a first image; analyzing the first image information and in response to the analysis performing a second set of input operations required to complete an information transfer operation associated with the computerize system; and analyzing second image information generated by the computerized system in response to the execution of the second set of input operation in order to validate a completion of the information transfer operation.

### FIELD OF THE INVENTION

The present invention relates to methods, systems and computer program products for performing information transfer using a virtual operator.

### BACKGROUND OF THE INVENTION

Many vendors and service providers work with multiple computerized systems that can differ from each other. These computerized systems can include legacy computerized systems (such as but not limited to traditional mainframe computers) as well as modern computerized systems. Typically, the software and/or hardware of these computerized systems are tailored to support unique customer applications.

A single human operator can interface with these multiple computerized systems and transfer information (enter information and alternatively or additionally retrieve information) to (or from) these computerized systems.

A human operation may repetitively perform time-consuming input operations (by using, for example, a keyboard or a mouse) in order to perform information transfer operations. These input operations usually cause a computerized system to display an image on a display, thus allowing the human operator to view the information that is being retrieved and/or entered, and eventually to verify that the information transfer operation was successfully completed. An information transfer operation is deemed successful if the appropriate information was transferred and if the computerized system completed the reception or provision of information.

There is a need to reduce the cost of information transfer operations while verifying that the information transfer was successfully completed.

### SUMMARY OF THE PRESENT INVENTION

Methods, systems and computer program products for performing information transfer using a virtual operator.

Conveniently, the method includes: executing, by a virtual operator, a first set of input operations such as to cause a computerized system to generate first image information representative of a first image; analyzing the first image information and in response to the analysis performing a second set of input operations required to complete an information transfer operation associated with the computerize system; and analyzing second image information generated by the computerized system in response to the execution of the second set of input operation in order to validate a completion of the information transfer operation.

Conveniently the computer program product includes: a computer usable medium including a computer readable program, wherein the computer readable program when executed on a computer causes the computer to: execute, by a virtual operator, a first set of input operations such as to cause a computerized system to generate first image information representative of a first image; analyze the first image information and in response to the analysis perform a second set of input operations required to complete an information transfer operation associated with the computerize system; and analyze second image information generated by the computerized system in response to the execution of the second set of input operation in order to validate a completion of the information transfer operation.

Conveniently the system for performing information transfer includes at least one computer adapted to host a image information analyzer, a virtual operator and a image information verifier; wherein the virtual operator is adapted to: (i) execute a first set of input operations such as to cause a computerized system to generate first image information representative of a first image; and (ii) perform, in response to the first analysis result, a second set of input operations required to complete an information transfer operation associated with the computerize system; wherein the image information analyzer is adapted to: (i) analyze the first image information and send to the virtual operator a first analysis result, and (ii) analyze second image information generated by the computerized system in response to the execution of the second set of input operation and to send to the image information verifier a second analysis result; and wherein the image information verifier is adapted to verify a successful completion of the information transfer operation in response to the second analysis result.

### BRIEF DESCRIPTION OF THE DRAWINGS

The present invention will be understood and appreciated more fully from the following detailed description taken in conjunction with the drawings in which:

FIG. 1 illustrates a system for information transfer and its environment, according to an embodiment of the invention;

FIG. 2 illustrates a system for information transfer and its environment, according to another embodiment of the invention;

FIG. 3 illustrates exemplary images according to an embodiment of the invention; and

FIG. 4 illustrates a method for performing information transfer operations, according to an embodiment of the invention.

### DETAILED DESCRIPTION OF THE DRAWINGS

Methods, systems and computer program products for executing information transfer operations. The information transfer operations can be executed in order to provide back-office services but this is not necessarily so.

Conveniently, a system having image information analysis, image information verification and virtual operator capabilities interfaces with one or more computerized systems and is capable of performing multiple input operations that invoke the one or more computerized systems to generate image information representative of one of more images (for example by displaying one or more images on one or more screens). The system can analyze the image information (for example examine data representative of the image, analyze displayed images, and the like) and in response retrieve and/or enter information and also can verify that an information transfer operation was successfully completed. The image information can be in various formats known in the art. For example a two dimensional grid of textual symbols, information representing image pixels and the like.

The interface with multiple different computerized systems is simplified by image information analysis that can be preformed regardless of the hardware and software configurations of the computerized systems.

Conveniently, the image analysis can involve applying Optical Character Recognition (OCR) software that translates an image of typewritten text into a machine-edible text. Yet for another non-limiting example the image information analysis can involve analyzing data representative of images, such as control and data signals that would have been sent to a display or a display interface. Yet for a non-limiting example, a buffer that stores image information can be read in order to retrieve the image information.

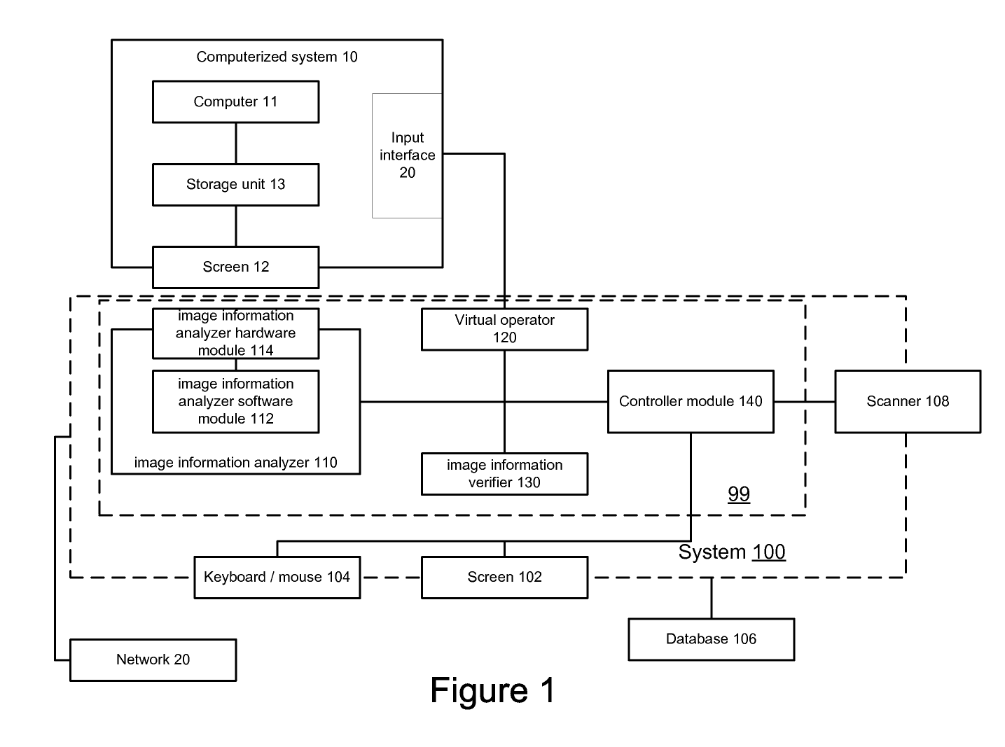

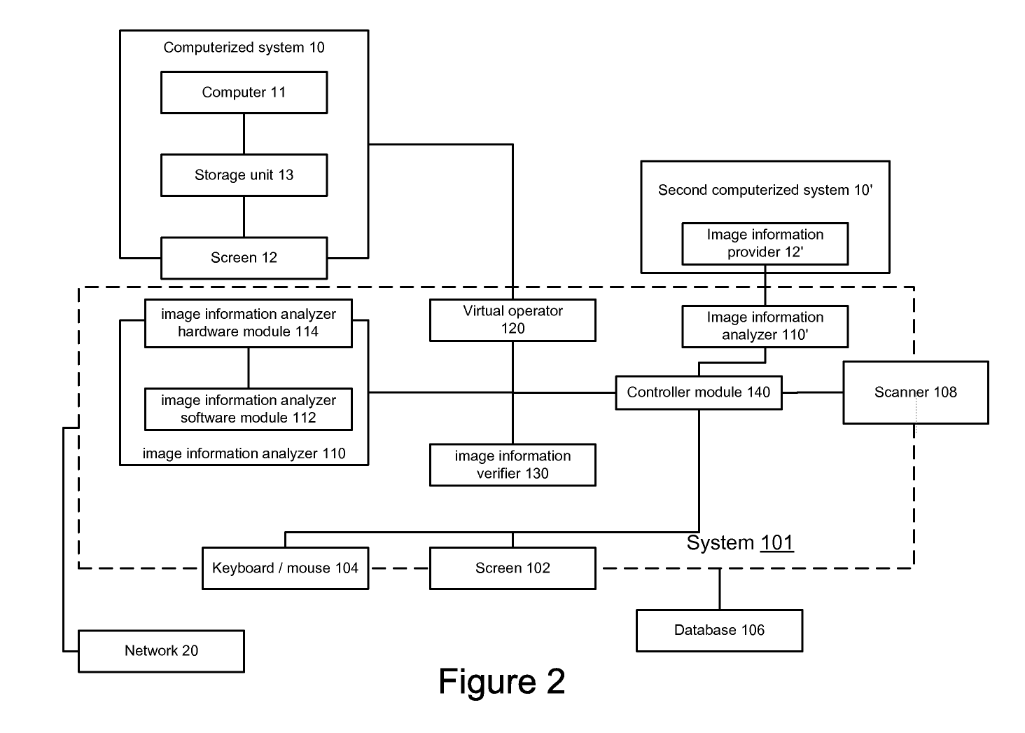

For simplicity of explanation FIG. 1 illustrates image information that is displayed on a screen but it is noted that image information of other formats can be analyzed and/or verified. For example, FIG. 2 illustrates a second computerized system 10′ that has an image information provider 12′ that differs from a screen.

FIG. 1 illustrates system 100 and its environment, according to an embodiment of the invention.

System 100 can interface with multiple computerized systems. For simplicity of explanation FIG. 1 illustrates a single computerized system 10 that is also referred to as first computerized system 10. Computerized system 10 includes a screen 12, at least one computer 11, at least one storage unit 13 and an input interface 20 adapted to receive input signals representative of keystrokes, mouse clicks and the like.

Computerized system 10 is adapted to execute one or more applications. These applications may involve one or more input transfer operations. An application can involve multiple input transfer operations and can also involve a generation of image information and even a display of multiple images (at different points in time) on screen 12. Information to be transferred should appear on screen 12.

Each application can be executed by performing multiple input operations. For example, a log on session can involve performing multiple input operations in order to enter login and password information. The application can further require additional input operations that cause computerized system 10 to display multiple images, whereas each image can be analyzed and/or verified. At least one image can allow entering information while at least one image can allow retrieving information. Yet a further image can indicate that the information reception and/or the information provision were completed.

The input operations required for executing an application are known in advance. Accordingly, a virtual operator can be configured to perform these multiple input operations in order to enable the information transfer.

System 100 includes at least one computer (illustrated by box 99) that can host various software modules such as image information analyzer software module 112, virtual operator 120 and image information verifier 130. It is noted that image information analyzer software module 112 is connected to image information analyzer hardware 114 that in turn is capable of scanning an image displayed on screen 12. Image information analyzer software module 112 and image information analyzer hardware 114 form image information analyzer 110.

Conveniently, image information analyzer 110, virtual operator 120 and image information verifier 130 are controlled by controller module 140. It is further noted that system 100 can have other configuration, can have a distributed or centralized architecture, can at least be remotely positioned form computerized system 10, and the like.

Virtual operator 120 is adapted to: (i) execute a first set of input operations such as to cause computerized system 10 to display a first image on a screen, and (ii) perform, in response to the first analysis result, a second set of input operations required to complete an information transfer operation associated with the computerize system.

Image information analyzer 110 is adapted to: (i) analyze the first image and send to virtual operator 120 a first analysis result, and (ii) analyze a second image generated by computerized system 10 in response to the execution of the second set of input operation and to send to image information verifier 130 a second analysis result.

Conveniently, image information analyzer 110 also sends to image information verifier 130 the first analysis result, so that image information verifier 130 can verify that the first image is the expected image.

Image information verifier 130 is adapted to verify a successful completion of the information transfer operation in response to the second analysis result. Conveniently, it is also adapted to verify that the first image is the expected image. The verification can include comparing an image analysis result to an expected image that can be stored within storage unit 13 (or in another storage unit).

If information that is being transferred appears in the image then the comparison takes into account that information. For example, if system 100 executes an address change operation then one image can include the old address, another image can include the updated image and yet a further image can include an indication that the new address was successfully received by computerized system 10. Each image can include an image template (that is not affected by the content of the transferred information) as well as variable information (including transferred information and system indications).

Image information verifier 130 compares between images that appear on screen 12 and between synthetic images that may include predefined image templates and (depending upon the image) information representative of the transferred information.

For example, a first comparison can be made when system 100 expects screen 12 to display an image that includes an old address. A second comparison can be made when the updated address is expected to be displayed on screen 12. A third comparison can be made when screen 12 is expected to display an image that indicates that the address update was successfully completed.

According to another embodiment of the invention system 100 is adapted to define the first set and second set of input operations. The definition can include receiving information about the application that is being executed by computerized system 100, especially which input operations invoke the application and which images should be displayed and accordingly determine the first and second set of input operations.

If the location of a certain field that should be accessed in order to transfer information is not known in relation to an initial position of a cursor (or other graphical indicator) then system 100 can apply image processing techniques to detect the initial location of the cursor (or the other graphical indicator).

For example, if the cursor blinks, a comparison between different images taken in different points in time (not synchronized with the cursor blink frequency) can determine the location of the cursor. Yet for another example, system 100 can perform input operations that alter the location of the cursor and by comparing images taken in different points in time determine the location of the cursor. Once the location of the cursor is determined system 100 can determine which input operations are required for accessing the certain field and entering information to that field.

Conveniently, if image information verifier 130 determines that the expected image and the analyzed images do not match system 100 can generate an alert that can require a human operator to intervene.

The alert can be displayed on screen 102, and/or can be generated using a sound generator, but this is not necessarily so.

FIG. 2 illustrates system 101 and its environment according to another embodiment of the invention.

System 101 differs from system 100 by including an additional image analyzer 110′ that is adapted to analyze images displayed on screen 12′ of second computerized system 10′. In addition system 101 can interface with second computerized system 10′ in substantially the same manner that it interfaced first computerized system 10. It is further noted that system 101 can have an additional virtual operator, an additional image information verifier and even an additional controller but this is not necessarily so. For example one module can manage multiple computerized systems.

It is further noted that multiple computerized systems can share the same display. In this case there is a need for fewer image information analyzers.

System 101 can compare retrieved information from first computerized system 10 to information retrieved from second computerized system 10′. Thus, if one or more applications requires to receive information from multiple computerized systems then system 101 can receive said information and process it according to the application requirements. For example, system 101 can gather information from computerized systems 10 and 10′ and display the retrieved information on a single screen (such as screen 102).

System 101 can service many applications. One of the applications that were tested by the inventors included back-off services for insurance companies. The back-office services included receiving payments from customers, associating these payments to payments related to insurance polices and selectively accepting the payments.

According to an embodiment of the invention system 101 is adapted to retrieve an account number (for example by receiving that information from network 20 or by scanning a check by scanner 108), search (in database such as database 106) an insurance policy identifier associated with the account number, and initialize (by virtual operator 120) a first set of input operations that cause first computerized system 10 to provide an image (on screen 12) that includes at least the insurance policy number. Conveniently, that image includes the insurance policy number, the name of the policy owner and one or more due payments.

System 101 is able of extracting the name of a bank account owner and the amount of currency paid from the image of the check. Then, system 101 can compare the names of the insurance policy owner to the name of the bank account owner and compare the expected due payments to the amount of currency pad and if there is a match accept the payment.

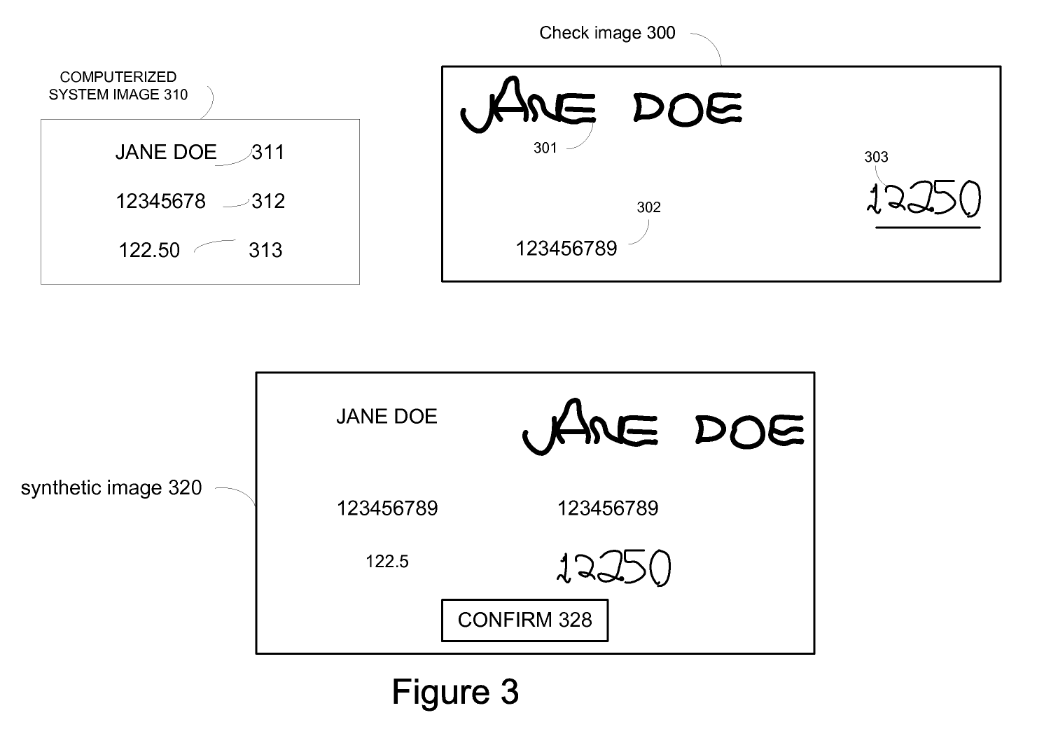

FIG. 3 illustrates various images and systems according to an embodiment of the invention.

Check image 300 is obtained by scanner 108 of system 101. It can include a bitmap (or other graphical representation) of the image as well as textual information that reflects the textual content of the check. For example check image 300 can include bank account owner image 301, account number image 302, and an image 303 of the amount of currency paid by the check.

A computerized system image 310 appears on screen 12. It includes the name (“Jane Doe”) of the insurance policy owner 311, account number “123456789” 312 and an amount of payment that is due “122.50” 313.

System 100 analyzes images 310 and 301-303 and generates synthetic image 320 that includes the textual information retrieved from screen 12 and various images extracted from check image 300.

Synthetic image 320 can include a “Confirm” icon 328 that can be used for confirming the information transfer operation.

System 100 can then request a human operator to compare the displayed images and validate the payment. System 100 can also analyze the check image and compare the analysis result (text) to the information retrieved from computerized system 10.

Human intervention can be required when the reliability of the image analysis is below a required threshold, where erroneous image analysis can have harmful effects, and the like.

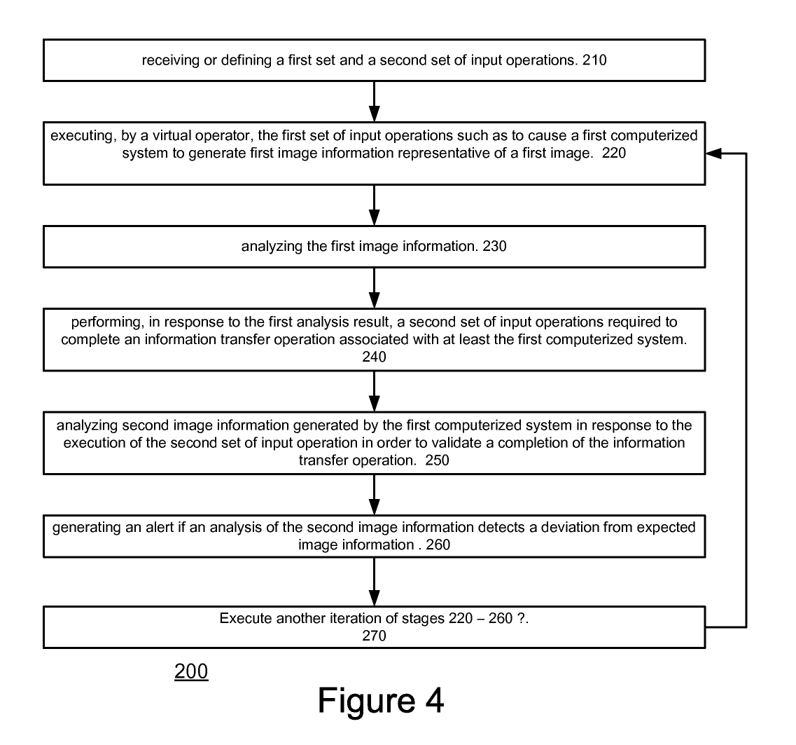

FIG. 4 illustrates a method for performing information transfer operations, according to an embodiment of the invention.

Method 200 starts by stage 210 of receiving or defining a first set and a second set of input operations.

Stage 210 is followed by stage 220 of executing, by a virtual operator, the first set of input operations such as to cause a first computerized system to generate image information (for a non-limiting example this stage may include displaying a first image on a screen).

Stage 220 is followed by stage 230 of analyzing the first image information.

Stage 230 is followed by stage 240 of performing, in response to the first analysis result, a second set of input operations required to complete an information transfer operation associated with at least the first computerized system. It is noted that stage 230 can be followed by verifying the first image information and generating an alert if the first image information differs from an expected first image information.

Stage 240 is followed by stage 250 of analyzing second image information generated by the first computerized system in response to the execution of the second set of input operation in order to validate a completion of the information transfer operation.

Conveniently stage 240 of performing a second set of operations can include performing image processing to determine a location of a curser and in response to the analysis determining input operations required for inputting information to a predefined location in the screen.

Stages 240 and 250 can be followed by stage 260 of generating an alert if an analysis of the second image information detects a deviation from expected image information.

Conveniently, method 200 further includes stage 270 of executing one or more iterations of stages 200-260 and, alternatively or additionally executing at least one operation by a second computerized system or even a system that executes one or more stages out of stages 200-260 (herein referred to as the method executing system) in order to complete an execution of a certain application.

Conveniently, stage 270 can include gaining information from the second computerized system and comparing retrieved information from the first computerized system to information retrieved from the second computerized system.

Conveniently, stage 270 can include gaining information from the method executing system and comparing retrieved information from the first computerized system to information retrieved from the second computerized system.

It is noted that stage 270 can include comparing between information retrieved from (or provided by) more than two systems.

Conveniently, stage 270 can include receiving a account number line from a method executing system (or from the second computerized system), searching an insurance policy identifier associated with the account number and initializing a first set of input operations that cause the first computerized system to provide an image that includes at least the insurance policy number. Conveniently, that image includes the insurance policy number, the name of the policy owner, one or more due payments, while the method executing system (or the second computerized system) is able of extracting the name of a bank account owner and the payment value from the image of the check. The comparing includes comparing the names of the insurance policy owner to the name of the bank account owner and comparing the expected due payments to the payment value and the like.

It is further noted that method 200 can include analyzing more than two images and also may include validating more than a single image.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Variations, modifications, and other implementations of what is described herein will occur to those of ordinary skill in the art without departing from the spirit and the scope of the invention as claimed.

Accordingly, the invention is to be defined not by the preceding illustrative description but instead by the spirit and scope of the following claims.

We claim:

1. A method for performing information transfer, the method comprises: executing, by a virtual operator, a first set of input operations such as to cause a computerized system to generate first image information representative of a first image; analyzing the first image information and in response to the analysis performing a second set of input operations required to complete an information transfer operation associated with the computerize system; and analyzing second image information generated by the computerized system in response to the execution of the second set of input operation in order to validate a completion of the information transfer operation.

2. The method according to claim 1 further comprising defining the first set and second set of input operations.

3. The method according to claim 1 wherein the first image information forms an image on a screen and wherein the analyzing comprises analyzing the first image.

4. The method according to claim 3 wherein the performing of the second set of operations comprises performing image processing to determine a location of a curser and in response to the analysis determining input operations required for inputting information to a predefined location in the screen.

5. The method according to claim 1 further comprising generating an alert if an analysis of image information detects a deviation from expected image information.

6. The method according to claim 1 further comprising executing, by another computerized system, a set of operation that retrieve information from the other computerized system and to compare retrieved information from the first computerized system to information retrieved from the second computerized system.

7. The method according to claim 1 wherein the first image information comprises an account number line and wherein the method further comprises searching an insurance policy identifier associated with the account number and initializing a first sequence of stage that cause a computerized system to provide an image that comprises an insurance policy number.

8. The method according to claim 1 wherein the method comprises gathering information from multiple systems and displaying the retrieved information on a single screen.

9. A computer program product comprising a computer usable medium including a computer readable program, wherein the computer readable program when executed on a computer causes the computer to: execute, by a virtual operator, a first set of input operations such as to cause a computerized system to generate first image information representative of a first image; analyze the first image information and in response to the analysis perform a second set of input operations required to complete an information transfer operation associated with the computerize system; and analyze second image information generated by the computerized system in response to the execution of the second set of input operation in order to validate a completion of the information transfer operation.

10. The computer program product according to claim 9 wherein the first image information forms an image on a screen and the computer readable program when executed on a computer causes the computer to analyze the image formed on the screen.

11. The computer program product according to claim 10 wherein the computer readable program when executed on a computer causes the computer to perform image processing to determine a location of a curser and in response to the analysis determine input operations required for inputting information to a predefined location in the screen.

12. The computer program product according to claim 9 wherein the computer readable program when executed on a computer causes the computer to generate an alert if an analysis of image information detects a deviation from an expected image information.

13. The computer program product according to claim 9 wherein the computer readable program when executed on a computer causes the computer to compare retrieved information to information retrieved from the second computerized system.

14. The computer program product according to claim 9 wherein the computer readable program when executed on a computer causes the computer to gather information from multiple systems and to display the retrieved information on a single screen.

15. A system for performing information transfer, the system comprises at least one computer adapted to host a image information analyzer, a virtual operator and a image information verifier; wherein the virtual operator is adapted to: (i) execute a first set of input operations such as to cause a computerized system to generate first image information representative of a first image; and (ii) perform, in response to the first analysis result, a second set of input operations required to complete an information transfer operation associated with the computerize system; wherein the image information analyzer is adapted to: (i) analyze the first image information and send to the virtual operator a first analysis result, and (ii) analyze second image information generated by the computerized system in response to the execution of the second set of input operation and to send to the image information verifier a second analysis result; and wherein the image information verifier is adapted to verify a successful completion of the information transfer operation in response to the second analysis result.

16. The system according to claim 15 wherein the image information verifier is adapted to analyze a first image displayed by the computerized system.

17. The system according to claim 15 further adapted to define the first set and second set of input operations.

18. The system according to claim 15 adapted to perform image processing to determine a location of a curser and in response to the analysis determine input operations required for inputting information to a predefined location in the screen.

19. The system according to claim 15 further adapted to generate an alert if an analysis of image information detects a deviation from an expected image information.

20. The system according to claim 15 further adapted to compare retrieved information from a first computerized system to information retrieved from a second computerized system.
